(19) United States
(12) Patent Application Publication
(10) Pub. No.: US 2003/0167123 A1
(43) Pub. Date: Sep. 4, 2003

(54) Vehicle control apparatus

(75) Inventors: Terumi Nakazawa, Naka (JP); Kenichi Mizuishi, Hachioji (JP); Shirou Oouchi, Hitachinaka (JP)

Correspondence Address: CROWELL & MORING LLP, INTELLECTUAL PROPERTY GROUP, P.O. BOX 14300, WASHINGTON, DC, 20044-4300, US

(73) Assignee: Hitachi, Ltd

(21) Appl. No.: 10/299,687

(22) Filed: Nov. 20, 2002

(30) Foreign Application Priority Data
Mar. 1, 2002 (JP) 2002-055352

(51) Int. Cl. G06F 17/00

(52) U.S. Cl. 701/301; 701/96; 340/436

(57) ABSTRACT

A vehicle control apparatus is provided in which the use of a camera has enhanced the safety. A distance detecting sensor detects the distance between a vehicle, which is positioned ahead of a self-vehicle, and the self-vehicle. Also, the camera detects the vehicle positioned ahead of the self-vehicle. If the distance detecting sensor detects the ahead-positioned vehicle, a control unit utilizes the camera, thereby judging the state of rear lamps of the ahead-positioned vehicle. Then, if the control unit has detected a malfunction of the rear lamps of the ahead-positioned vehicle, the control unit, by a communications unit, communicates the malfunction to the driver of the ahead-positioned vehicle and/or to a public agency.

### BACKGROUND AND SUMMARY OF THE INVENTION

The present invention relates to a vehicle control apparatus. In particular, it relates to a vehicle control apparatus that is suitable for detecting information on an ahead-positioned vehicle with the use of a camera so as to perform the control over a vehicle and the transmission of the information.

From conventionally, as the headlight control method in a vehicle, there has been known a method of changing the horizontal illumination direction of the headlights at a curve. Such a method has been described in, e.g., JP-A-60-64044 or JP-A-7-125571.

In the above-described conventional method, however, the front lamps are controlled in a manner that is convenient only for the running of the self-vehicle. Namely, no consideration has been given to the safety with respect to the other vehicles such as an ahead-positioned vehicle and an oncoming vehicle that is oncoming on the opposite lane.

It is an object of the present invention to provide a vehicle control apparatus that allows the safety to be enhanced by using a camera or the like.

(1) In order to accomplish the above-described object, a vehicle control apparatus according to a 1st solution of the present invention includes the following configuration components: A distance detecting sensor for detecting the distance between a vehicle positioned ahead of the self-vehicle and the self-vehicle, a camera for detecting the vehicle positioned ahead of the self-vehicle, a control unit for making a response to the detection of the ahead-positioned vehicle by the distance detecting sensor, and for judging the state of rear lamps of the ahead-positioned vehicle with the use of the camera, and a communications unit that, if the control unit has detected a malfunction of the rear lamps of the ahead-positioned vehicle, communicates the malfunction to the driver of the ahead-positioned vehicle and/or to a public agency.

(2) Also, in order to accomplish the above-described object, a vehicle control apparatus according to a 2nd solution of the present invention includes the following configuration components: A camera for detecting a vehicle positioned ahead of the self-vehicle, and a control unit for making a response to the detection of hard brake information from the ahead-positioned vehicle with the use of a signal from the camera, and for issuing a warning by an alarm unit.

(3) Moreover, in order to accomplish the above-described object, a vehicle control apparatus according to a 3rd solution of the present invention includes the following configuration components: A camera for detecting a vehicle positioned ahead of the self-vehicle, and a control unit for making a response to the detection of hard brake information from the ahead-positioned vehicle with the use of a signal from the camera, and for outputting an instruction of the full-closing of a throttle valve and/or that of the automatic control over a brake.

The configuration given as described above makes it possible to enhance the safety of the self-vehicle.

Other objects, features and advantages of the invention will become apparent from the following description of the embodiments of the invention taken in conjunction with the accompanying drawings.

### BRIEF DESCRIPTION OF THE DRAWINGS

FIG. 1 is a system block diagram for illustrating the configuration of a vehicle control apparatus according to a 1st embodiment of the present invention;

FIG. 2 is an explanatory diagram for explaining an ahead-positioned vehicle and a behind-positioned vehicle at the time of detecting the state of rear lamps of the ahead-positioned vehicle by the vehicle control apparatus according to the 1st embodiment of the present invention;

FIG. 3 is a flowchart for illustrating the detection contents by a state detecting method for detecting the state of the rear lamps of the ahead-positioned vehicle by the vehicle control apparatus according to the 1st embodiment of the present invention;

FIG. 4 is a flowchart for illustrating the detection contents by a state detecting method for detecting the state of the rear lamps of the ahead-positioned vehicle by a vehicle control apparatus according to a 2nd embodiment of the present invention;

FIG. 5 is a flowchart for illustrating the control contents at the time of a hard brake of the ahead-positioned vehicle by a vehicle control apparatus according to a 3rd embodiment of the present invention;

FIG. 6 is a flowchart for illustrating the control contents at the time of a hard brake of the ahead-positioned vehicle by a vehicle control apparatus according to a 4th embodiment of the present invention;

FIG. 7 is a flowchart for illustrating the contents of the control over a lamp illumination angle of the self-vehicle by a vehicle control apparatus according to a 5th embodiment of the present invention;

FIG. 8 is an explanatory diagram for explaining the control over the lamp illumination angle of the self-vehicle by the vehicle control apparatus according to the 5th embodiment of the present invention;

FIG. 9 is a flowchart for illustrating the contents of the control over the lamp illumination angle of the self-vehicle by a vehicle control apparatus according to a 6th embodiment of the present invention; and

FIG. 10 is an explanatory diagram for explaining the control over the lamp illumination angle of the self-vehicle by the vehicle control apparatus according to the 6th embodiment of the present invention.

### DETAILED DESCRIPTION OF THE EMBODIMENTS

Referring to the accompanying drawings, the detailed explanation will be given below concerning the embodiments of the present invention.

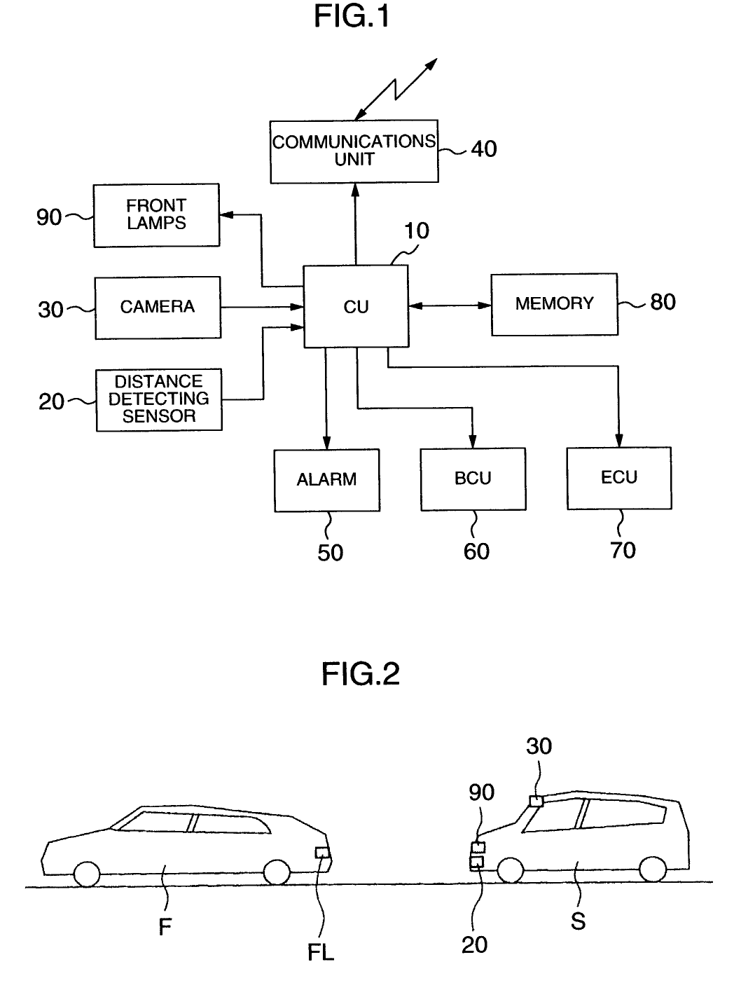

Hereinafter, using FIGS. 1 to 3, the explanation will be given below regarding the configuration of a vehicle control apparatus according to a 1st embodiment of the present invention.

First, using FIG. 1, the explanation will be given below concerning the system configuration of the vehicle control apparatus according to the present embodiment.

FIG. 1 is a system block diagram for illustrating the configuration of the vehicle control apparatus according to the 1st embodiment of the present invention.

The information on the inter-vehicles distance between an ahead-positioned vehicle and the self-vehicle is inputted from a distance detecting sensor 20 into a control unit (: CU) 10. As the distance detecting sensor 20, there is employed a millimeter-wave radar apparatus, a Doppler radar apparatus, or the like. A camera 30 takes photographs of an image existing ahead of the self-vehicle (including the image of the ahead-positioned vehicle that is running ahead), then converting the image data into an electrical signal so as to input the electrical signal into the control unit 10. Based on the information from the distance detecting sensor 20 and the camera 30, the control unit 10 detects the situation of rear lamps (e.g., tail lamps and brake lamps) of the ahead-positioned vehicle, then communicating the detection result to the ahead-positioned vehicle via a communications unit 40. As the communications unit 40, there can be employed, e.g., an inter-vehicles communications and an Internet telephone. The data for judging the situation of the rear lamps has been stored in a memory 80.

An alarm unit 50, a brake control unit (: BCU) 60, an engine control unit (: ECU) 70, and front lamps 90 will be used in the other embodiments. Accordingly, the details thereof will be explained later.

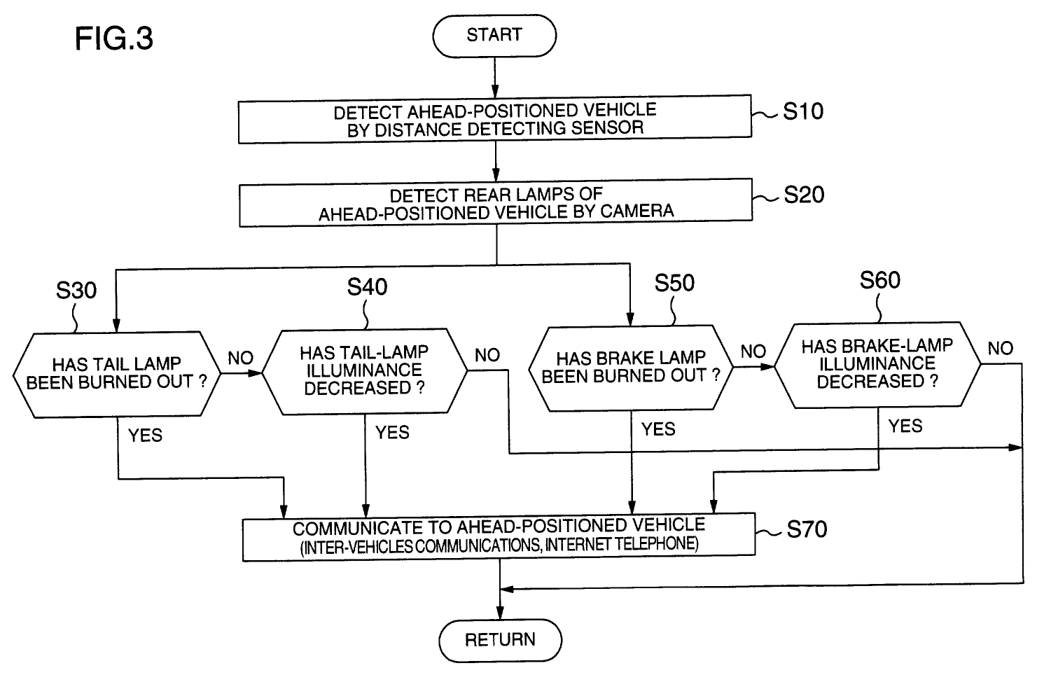

Next, using FIG. 2 and FIG. 3, the explanation will be given below concerning a state detecting method for detecting the state of the rear lamps of the ahead-positioned vehicle by the vehicle control apparatus according to the present embodiment.

FIG. 2 is an explanatory diagram for explaining the ahead-positioned and the behind-positioned vehicles at the time of detecting the state of the rear lamps of the ahead-positioned vehicle by the vehicle control apparatus according to the 1st embodiment of the present invention. FIG. 3 is a flowchart for illustrating the detection contents by the state detecting method for detecting the state of the rear lamps of the ahead-positioned vehicle by the vehicle control apparatus according to the 1st embodiment of the present invention.

Assume that, as illustrated in FIG. 2, the ahead-positioned vehicle F is running ahead of the self-vehicle S. At the rear of the ahead-positioned vehicle F, there are provided the rear lamps FL such as the tail lamps and the brake lamps. Meanwhile, the self-vehicle S includes the distance detecting sensor 20, the camera 30, and the front lamps 90.

At a step S10 in FIG. 3, the control unit 10 illustrated in FIG. 1 detects the ahead-positioned vehicle F, using the distance detecting sensor 20. Concretely, when the inter-vehicles distance between the ahead-positioned vehicle F and the self-vehicle, which has been detected by the distance detecting sensor 20, becomes shorter than a predetermined value, e.g., 100 meters, the control unit 10 is assumed to have detected the ahead-positioned vehicle F.

Next, at a step S20, the control unit 10 detects the rear lamps FL of the ahead-positioned vehicle F, using the camera 30.

During the night or in a similar situation, if, of the rear lamps FL of the ahead-positioned vehicle F, one of the tail lamps has been lit up, at a step S30, the control unit 10 judges whether or not another tail lamp has been burned out. Usually, the two tail lamps are each provided on both sides at the rear of the vehicle, and the two tail lamps are seldom burned out simultaneously. Thus, based on the image data captured by the camera 30, the control unit 10, in the following case, judges that another tail lamp has been burned out: Despite the fact that the one tail lamp has been lit up, it is impossible to recognize the light-emission (i.e., the illuminance is equal to 0) of another tail lamp that is supposed to exist at a position which is left-right symmetrical to the lit-up tail lamp.

Moreover, if another tail lamp has been burned out, at a step S70, the control unit 10 communicates the burning-out of another tail lamp to the ahead-positioned vehicle F, using the communications unit 40 such as the inter-vehicles communications and the Internet telephone.

Also, in the judgement at the step S30, if the control unit 10 has judged that another tail lamp has been not burned out, at a step S40, the control unit 10 judges whether or not the illuminance of another tail lamp has decreased. Here, the Vehicle Safety Standard stipulates that the tail lamps can be visually recognized in the night from 300 meters behind. Thus, concretely, this condition is converted into the illuminance of the tail lamps, then being stored in advance into the memory 80 in such a manner that the illuminance of the tail lamps must be higher than y lux at a position x meters behind the tail lamps. Furthermore, based on the information on the illuminance of another tail lamp detected by the camera 30, y1, and the inter-vehicles distance detected by the distance detecting sensor 20, x1, the control unit 10 determines the illuminance of another tail lamp at the distance x meters as (y1×(x1/x)²). If this value is found to be smaller than the illuminance that becomes the criterion (i.e., y lux), the control unit 10 judges that the illuminance of another tail lamp has decreased. The illuminance data that becomes the criterion has been stored in the memory 80. If the illuminance has decreased, at the step S70, the control unit 10 communicates the decrease in the illuminance to the ahead-positioned vehicle F, using the communications unit 40 such as the inter-vehicles communications and the Internet telephone. If the illuminance has not decreased, the control unit 10 terminates the processing.

Also, in a state where the brake has been just stepped on and one of the brake lamps is lit up, at a step S50, the control unit 10 judges whether or not another brake lamp has been burned out. First, as to whether or not the brake has been just stepped on, the control unit 10 detects a great change in the projection area of the ahead-positioned vehicle F photographed by the camera 30. Then, in the following case, the control unit 10 judges that the brake has been just stepped on: The change is found to be greater than a rate determined in advance, namely, the projection area steeply becomes larger. Also, as another method, in the case where the illuminance of one lamp (in short, one of the brake lamps), which is other than the tail lamps of the ahead-positioned vehicle F and is captured by the camera 30, becomes larger than a predetermined level, the control unit 10 judges that the brake has been just stepped on. Moreover, as still another method, based on the data on the inter-vehicles distance detected by the distance detecting sensor 20 between the ahead-positioned vehicle and the self-vehicle, the control unit 10 detects a change in this inter-vehicles distance, then, in the following case, judging that the brake has been just stepped on: The change is found to be greater than a rate determined in advance, namely, the inter-vehicles distance steeply becomes narrower.

If the control unit 10 has judged that the brake pedal has been stepped on, the control unit 10 judges whether or not another brake lamp has been burned out. Usually, the two brake lamps are each provided on both sides at the rear of the vehicle, and the two brake lamps are seldom burned out simultaneously. Thus, based on the image data captured by the camera 30, the control unit 10, in the following case, judges that another brake lamp has been burned out: Despite the fact that the one brake lamp has been lit up, it is impossible to recognize the light-emission (i.e., the illuminance is equal to 0) of another brake lamp that is supposed to exist at a position which is left-right symmetrical to the lit-up brake lamp.

Moreover, if another brake lamp has been burned out, at the step S70, the control unit 10 communicates the burning-out of another brake lamp to the ahead-positioned vehicle F, using the communications unit 40 such as the inter-vehicles communications and the Internet telephone.

Also, in the judgement at the step S50, if the control unit 10 has judged that another brake lamp has been not burned out, at a step S60, the control unit 10 judges whether or not the illuminance of another brake lamp has decreased. Here, the Vehicle Safety Standard stipulates that the brake lamps can be visually recognized from 100 meters behind. Thus, concretely, this condition is converted into the illuminance of the brake lamps, then being stored in advance into the memory 80 in such a manner that the illuminance of the brake lamps must be higher than y2 lux at a position x2 meters behind the brake lamps. Furthermore, based on the information on the illuminance of another brake lamp detected by the camera 30, y3, and the inter-vehicles distance detected by the distance detecting sensor 20, x3, the control unit 10 determines the illuminance of another brake lamp at the distance x2 meters as (y3×(x3/x2)²). If this value is found to be smaller than the illuminance that becomes the criterion (i.e., y2 lux), the control unit 10 judges that the illuminance of another brake lamp has decreased. The illuminance data that becomes the criterion has been stored in the memory 80. If the illuminance has decreased, at the step S70, the control unit 10 communicates the decrease in the illuminance to the ahead-positioned vehicle F, using the communications unit 40 such as the inter-vehicles communications and the Internet telephone. If the illuminance has not decreased, the control unit 10 terminates the processing.

Incidentally, at the step S10, the control unit 10, using the distance detecting sensor 20, has detected the inter-vehicles distance between the ahead-positioned vehicle F and the self-vehicle. Then, when the inter-vehicles distance becomes the predetermined one, the control unit 10 has started the processing. However, the control unit 10 may start the processing on the basis of information on the ahead-positioned vehicle F from the camera 30. Concretely, the control unit 10, based on a signal from the camera 30, may judge the size (i.e., the transverse width, the height, or the projection area) of the ahead-positioned vehicle. Then, when the size becomes larger than a predetermined one, the control unit 10 may start the processing at the step 20 and thereafter.

As having been explained so far, based on the information detected by the camera, the present embodiment makes it possible to detect the wire-breaking or substantial disconnection and the illuminance decrease in the rear lamps such as another tail lamp and another brake lamp. In addition, the present embodiment allows the detection results to be communicated to the ahead-positioned vehicle. This condition makes it possible to enhance the safety of the ahead-positioned vehicle.

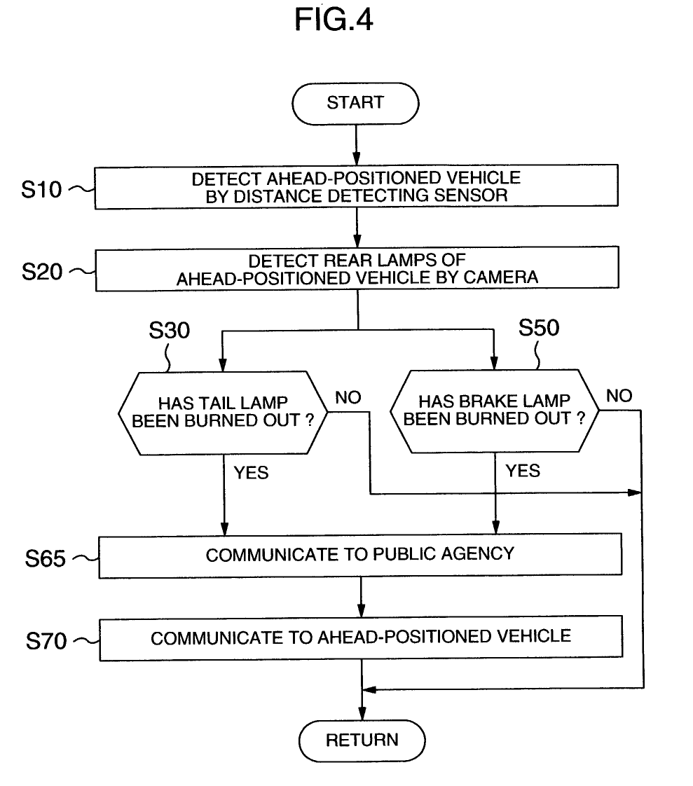

Next, using FIG. 4, the explanation will be given below concerning the configuration/operation of a vehicle control apparatus according to a 2nd embodiment of the present invention. Incidentally, the system configuration of the vehicle control apparatus according to the present embodiment is basically the same as the system configuration illustrated in FIG. 1.

FIG. 4 is a flowchart for illustrating the detection contents by a state detecting method for detecting the state of the rear lamps of the ahead-positioned vehicle by the vehicle control apparatus according to the 2nd embodiment of the present invention.

The processing contents at steps S10 to S30 and S50 illustrated in FIG. 4 are basically the same as those illustrated in FIG. 3.

During the night or in a similar situation, if, of the rear lamps FL of the ahead-positioned vehicle F, one of the tail lamps has been lit up, at a step S30, the control unit 10 judges whether or not another tail lamp has been burned out. Usually, the two tail lamps are each provided on both sides at the rear of the vehicle, and the two tail lamps are seldom burned out simultaneously. Thus, based on the image data captured by the camera 30, the control unit 10, in the following case, judges that another tail lamp has been burned out: Despite the fact that the one tail lamp has been lit up, it is impossible to recognize the light-emission (i.e., the illuminance is equal to 0) of another tail lamp that is supposed to exist at a position which is left-right symmetrical to the lit-up tail lamp.

In the judgement at the step S30, if the control unit 10 has judged that another tail lamp has been burned out, at a step S65, the control unit 10 communicates the burning-out of another tail lamp of the ahead-positioned vehicle F to a public agency such as the police and the Ministry of Transport, using the communications unit 40 such as the inter-vehicles communications and the Internet telephone. This public agency is capable of transmitting caution information to the driver who has failed to perform enough maintenance.

Moreover, at a step S70, the control unit 10 communicates the burning-out of another tail lamp to the ahead-positioned vehicle F, using the communications unit 40 such as the inter-vehicles communications and the Internet telephone.

Also, in the judgement at a step S50, if the control unit 10 has judged that another brake lamp has been burned out, at the step S65, the control unit 10 communicates the burning-out of another brake lamp of the ahead-positioned vehicle F to the public agency such as the police and the Ministry of Transport, using the communications unit 40 such as the inter-vehicles communications and the Internet telephone. This public agency is capable of transmitting caution information to the driver who has failed to perform enough maintenance.

Moreover, at the step S70, the control unit 10 communicates the burning-out of another brake lamp to the ahead-positioned vehicle F, using the communications unit 40 such as the inter-vehicles communications and the Internet telephone.

As having been explained so far, the present embodiment, based on the information detected by the camera, makes it possible to detect the wire-breaking and illuminance decrease in the rear lamps such as another tail lamp and another brake lamp. In addition, the present embodiment allows the detection results to be communicated to the public agency and the ahead-positioned vehicle. This condition makes it possible to enhance the safety of the ahead-positioned vehicle.

Next, using FIG. 5, the explanation will be given below concerning the configuration/operation of a vehicle control apparatus according to a 3rd embodiment of the present invention.

FIG. 5 is a flowchart for illustrating the control contents at the time of a hard brake of the ahead-positioned vehicle by the vehicle control apparatus according to the 3rd embodiment of the present invention.

The system configuration of the vehicle control apparatus according to the present embodiment is basically the same as the system configuration illustrated in FIG. 1. In the present embodiment, however, in addition to the explanation given in the 1st embodiment, the alarm unit 50 is further employed. The alarm unit 50 is a unit for issuing a warning to the driver of the self-vehicle by using sound, light, vibration, or the like. Incidentally, in the present embodiment, the communications unit 40 is not employed.

At a step S100, based on a signal from the camera 30, the control unit 10 detects that the ahead-positioned vehicle F has just applied a hard brake. Concretely, using the camera 30, the control unit 10 checks the size (i.e., the height, the width, the projection area, or the like) of the ahead-positioned vehicle. Then, if the size is found to have changed greatly, the control unit 10 can judge that the ahead-positioned vehicle has just applied a brake. Furthermore, if the change rate at which the size of the ahead-positioned vehicle F has become larger is found to be greater than a predetermined rate, the control unit 10 judges that the hard brake has just been applied.

Next, at a step S110, as soon as the control unit 10 detects that the ahead-positioned vehicle has applied the hard brake at the step S100, the control unit 10 issues a warning, which indicates that the ahead-positioned vehicle has applied the hard brake, to the driver of the self-vehicle via the alarm unit 50. This allows the driver of the self-vehicle to hasten the braking control-operation over the self-vehicle, thereby making it possible to avoid a rear-end collision or the like.

Also, the present embodiment exhibits an effect toward a cutting-in or the like from an adjacent lane. When, e.g., another vehicle cuts in from an adjacent lane on a one-side two-lane road, there occur some cases where the distance detecting sensor 20 such as the millimeter-wave radar cannot detect the cutting-in vehicle because of the narrow projection angle of its radar or radio wave. Even in this case, the camera 30 can capture the cutting-in vehicle because of its wide photographing angle. Thus, using a signal from the camera 30, the control unit 10 identifies the cutting-in vehicle from the adjacent lane or the like, then checking the size (i.e., the height, the width, the projection area, or the like) of the vehicle. Then, if the size is found to have changed greatly, the control unit 10 can judge that the ahead-positioned vehicle that had cut in has just applied a brake. Furthermore, if the change rate at which the size of the ahead-positioned vehicle has become larger is found to be greater than a predetermined rate, the control unit 10 judges that a hard brake has just been applied.

Also, the following configuration is possible: In addition to the case where the cutting-in vehicle has applied the hard brake, in the case as well where the cutting-in vehicle has applied the brake and there has just appeared the cutting-in vehicle, alarms corresponding thereto are issued.

As having been explained so far, based on the information detected by the camera, the present embodiment makes it possible to detect the hard-brake state or the cutting-in state of the ahead-positioned vehicle. In addition, the present embodiment issues the warning to the driver. This condition makes it possible to avoid a rear-end collision or the like.

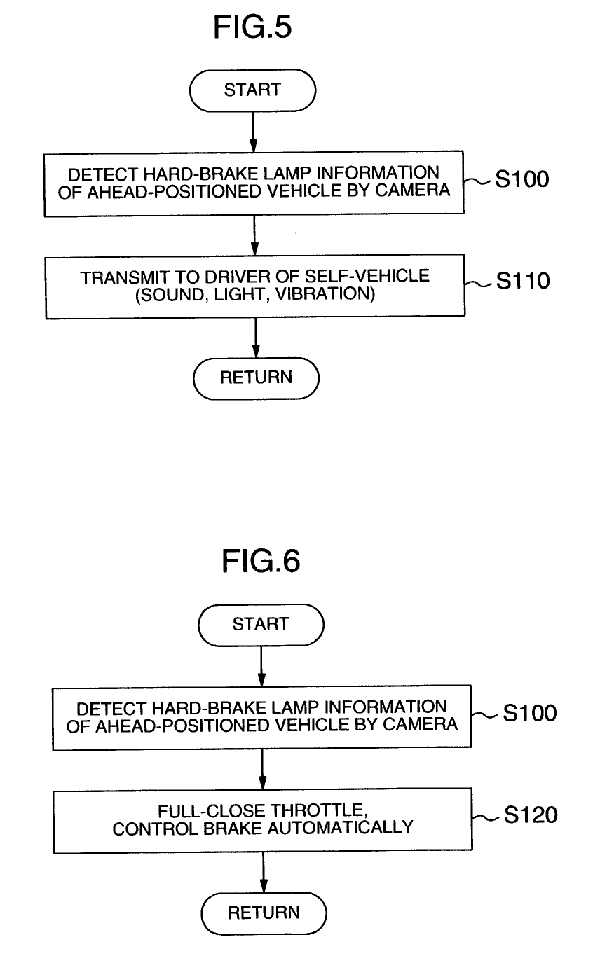

Next, using FIG. 6, the explanation will be given below concerning the configuration/operation of a vehicle control apparatus according to a 4th embodiment of the present invention.

FIG. 6 is a flowchart for illustrating the control contents at the time of a hard brake of the ahead-positioned vehicle by the vehicle control apparatus according to the 4th embodiment of the present invention.

The system configuration of the vehicle control apparatus according to the present embodiment is basically the same as the system configuration illustrated in FIG. 1. In the present embodiment, however, in addition to the explanation given in the 1st embodiment, the brake control unit 60 and the engine control unit 70 are further employed. The brake control unit 60 is a unit for automatically applying a brake in accordance with an instruction from the control unit 10. The engine control unit 70 is a unit for full-closing a throttle valve in accordance with an instruction from the control unit 10. Incidentally, in the present embodiment, the communications unit 40 is not employed.

At a step S100, based on a signal from the camera 30, the control unit 10 detects that the ahead-positioned vehicle F has just applied a hard brake. Concretely, using the camera 30, the control unit 10 checks the size (i.e., the height, the width, the projection area, or the like) of the ahead-positioned vehicle. Then, if the size is found to have changed greatly, the control unit 10 can judge that the ahead-positioned vehicle has just applied a brake. Furthermore, if the change rate at which the size of the ahead-positioned vehicle F has become larger is found to be greater than a predetermined rate, the control unit 10 judges that the hard brake has just been applied.

Next, at a step S120, as soon as the control unit 10 detects that the ahead-positioned vehicle has applied the hard brake at the step S100, the control unit 10 issues the instruction to the engine control unit 70, thereby full-closing the throttle valve. Also, the control unit 10 issues the instruction to the brake control unit 60, thereby applying the brake automatically. This allows the driver of the self-vehicle to hasten the braking control-operation over the self-vehicle, thereby making it possible to avoid a rear-end collision or the like.

Also, the following configuration is possible: Depending on the extent of the approach to the ahead-positioned vehicle (i.e., the rate at which the size of the ahead-positioned vehicle is changing), as a 1st step, the throttle valve is full-closed. Moreover, if the extent of the approach is large, as a 2nd step, the brake is automatically applied.

Also, the present embodiment exhibits an effect toward a cutting-in or the like from an adjacent lane. When, e.g., another vehicle cuts in from an adjacent lane on a one-side two-lane road, there occur some cases where the distance detecting sensor 20 such as the millimeter-wave radar cannot detect the cutting-in vehicle because of the narrow projection angle of its radar or radio wave. Even in this case, the camera 30 can capture the cutting-in vehicle because of its wide photographing angle. Thus, using a signal from the camera 30, the control unit 10 identifies the cutting-in vehicle from the adjacent lane or the like, then checking the size (i.e., the height, the width, the projection area, or the like) of the vehicle. Then, if the size is found to have changed greatly, the control unit 10 can judge that the ahead-positioned vehicle that had cut in has just applied a brake. Furthermore, if the change rate at which the size of the ahead-positioned vehicle has become larger is found to be greater than a predetermined rate, the control unit 10 judges that a hard brake has just been applied.

Also, the following configuration is possible: In addition to the case where the cutting-in vehicle has applied the hard brake, in the case as well where the cutting-in vehicle has applied the brake and there has just appeared the cutting-in vehicle, the throttle is full-closed, or the brake is automatically applied.

As having been explained so far, based on the information detected by the camera, the present embodiment makes it possible to detect the hard-brake state or the cutting-in state of the ahead-positioned vehicle. In addition, the present embodiment full-closes the throttle, or automatically applies the brake. This condition makes it possible to avoid a rear-end collision or the like.

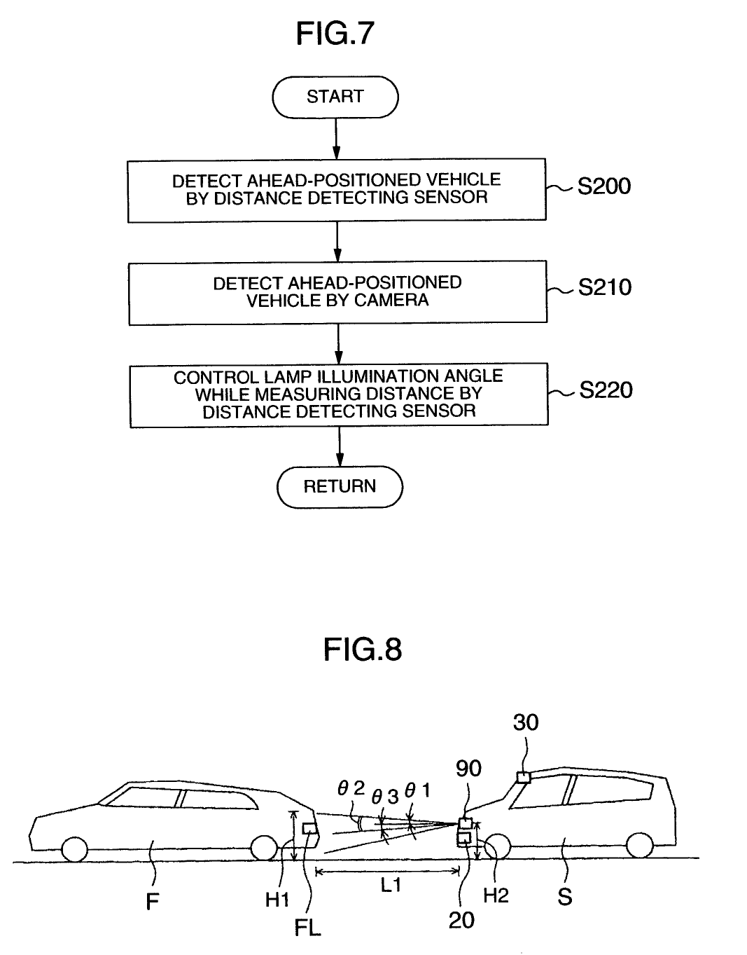

Next, using FIG. 7 and FIG. 8, the explanation will be given below concerning the configuration/operation of a vehicle control apparatus according to a 5th embodiment of the present invention.

FIG. 7 is a flowchart for illustrating the contents of the control over a lamp illumination angle of the self-vehicle by the vehicle control apparatus according to the 5th embodiment of the present invention. FIG. 8 is an explanatory diagram for explaining the control over the lamp illumination angle of the self-vehicle by the vehicle control apparatus according to the 5th embodiment of the present invention.

The system configuration of the vehicle control apparatus according to the present embodiment is basically the same as the system configuration illustrated in FIG. 1. In the present embodiment, however, in addition to the explanation given in the 1st embodiment, the front lamps 90 are further employed. The front lamps 90 include therein an illumination-angle changing mechanism that is capable of changing the illumination angle of each front lamp in the vertical direction. Accordingly, in accordance with an instruction from the control unit 10, it is possible to change the vertical-direction illumination angle of each front lamp. Incidentally, in the present embodiment, the communications unit 40 is not employed.

At a step S200 in FIG. 7, the control unit 10 illustrated in FIG. 1 detects the ahead-positioned vehicle F, using the distance detecting sensor 20. Concretely, when the inter-vehicles distance between the ahead-positioned vehicle F and the self-vehicle, which has been detected by the distance detecting sensor 20, becomes shorter than a predetermined value, e.g., 100 meters, the control unit 10 is assumed to have detected the ahead-positioned vehicle F.

Next, at a step S210, the control unit 10 detects the ahead-positioned vehicle F, using the camera 30.

Still next, at a step S220, the control unit 10 measures the distance between the ahead-positioned vehicle F and the self-vehicle, using the distance detecting sensor 20. Moreover, based on this measured distance, the control unit 10 issues the instruction to the front lamps 90, thereby controlling the vertical-direction illumination angle of each front lamp of the self-vehicle. Concretely, e.g., as illustrated in FIG. 8, let H2 denote the height of each front lamp 90 of the self-vehicle S. Then, the control unit 10 performs the control so that the top-edge part of the illumination angle of each front lamp will reach the position of the height H1 at the rear of the ahead-positioned vehicle F. At this time, letting θ1 denote the inclination that the top-edge part of the light illuminated from each front lamp 90 forms with respect to the horizontal direction, the following expression holds: tanθ1=(H1−H2)/L1. Also, assuming that the diffusion angle that the light illuminated from each front lamp 90 forms with respect to the central axis of the light is equal to θ2 (e.g., 5°), the inclination θ3 that the central axis of the light illuminated from each front lamp 90 forms with respect to the horizontal direction is given by: θ3=θ2−θ1. Consequently, assuming that the height H2 is an already-known value, e.g., 50 centimeters, and setting the height H1 as, e.g., 1 meters, the measurement and the recognition of the distance L1 between the ahead-positioned vehicle F and the self-vehicle S makes it possible to determine the angle θ1, which, further, makes it possible to determine the angle θ3.

The control unit 10 controls the illumination angle of each front lamp 90 (i.e., the inclination of the light's central axis with respect to the horizontal direction) so that the illumination angle becomes equal to this determined angle θ3.

Incidentally, in this case, the illumination angle of each front lamp 90 has been changed gradually, depending on the change in the inter-vehicles distance between the ahead-positioned vehicle and the self-vehicle. The illumination angle, however, may be changed in a step-like manner: For example, if the inter-vehicles distance between the ahead-positioned vehicle and the self-vehicle lies in the range of 100 to 300 meters, the illumination angle is changed to −2° and, if the inter-vehicles distance lies in the range of 50 to 100 meters, the illumination angle is changed to −4°.

Also, although, in the above-described explanation, the light from each front lamp 90 has been illuminated up to the position of the height H1 of the ahead-positioned vehicle F, the following illumination manner may be performed: Using the camera, the position illuminated by each front lamp 90 is detected while changing the illumination angle of each front lamp 90. Then, the illumination angle is controlled so that the light by each front lamp 90 will be illuminated up to the position of, e.g., one-half the height H1 of the ahead-positioned vehicle F.

As having been explained so far, the present embodiment permits the illumination angle of each front lamp to be changed depending on the distance between the ahead-positioned vehicle and the self-vehicle. On account of this, the light from each front lamp of the self-vehicle does not reach a rearview mirror or the like of the ahead-positioned vehicle. This condition makes it possible to prevent a visual illusion or confusion from being given to the driver of the ahead-positioned vehicle.

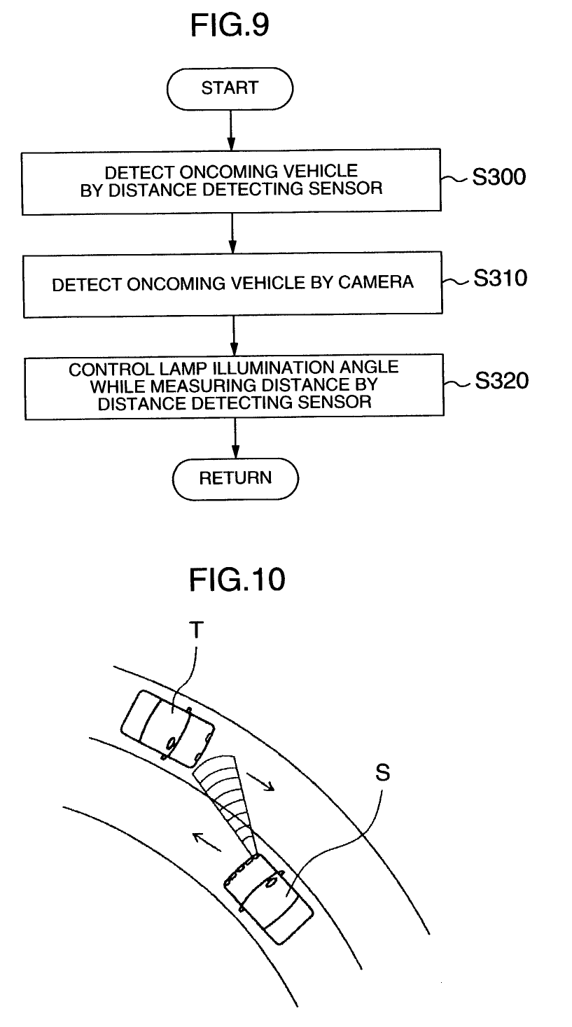

Next, using FIG. 9 and FIG. 10, the explanation will be given below concerning the configuration/operation of a vehicle control apparatus according to a 6th embodiment of the present invention.

FIG. 9 is a flowchart for illustrating the contents of the control over a lamp illumination angle of the self-vehicle by the vehicle control apparatus according to the 6th embodiment of the present invention. FIG. 10 is an explanatory diagram for explaining the control over the lamp illumination angle of the self-vehicle by the vehicle control apparatus according to the 6th embodiment of the present invention.

The system configuration of the vehicle control apparatus according to the present embodiment is basically the same as the system configuration illustrated in FIG. 1. In the present embodiment, however, in addition to the explanation given in the 1st embodiment, the front lamps 90 are further employed. The front lamps 90 include therein an illumination-angle changing mechanism that is capable of changing the illumination angle of each front lamp in the vertical direction. Accordingly, in accordance with an instruction from the control unit 10, it is possible to change the vertical-direction illumination angle of each front lamp. Incidentally, in the present embodiment, the communications unit 40 is not employed.

At a step S300 in FIG. 9, using the distance detecting sensor 20, the control unit 10 illustrated in FIG. 1 detects an oncoming vehicle T illustrated in FIG. 10. Concretely, when the inter-vehicles distance between the oncoming vehicle T and the self-vehicle, which has been detected by the distance detecting sensor 20, becomes shorter than a predetermined value, e.g., 100 meters, the control unit 10 is assumed to have detected the oncoming vehicle T. The present embodiment exhibits an effect especially when the self-vehicle and the oncoming vehicle pass each other on a curve. Accordingly, carrying out the present embodiment as follows permits the present embodiment to exhibit an outstanding effect: First, the fact that the self-vehicle S is now running on a curve is detected using a steering angle sensor, a yaw rate sensor, or a transverse G sensor. Then, in the case where the self-vehicle S is running on the curve in this way, the step S300 is executed.

Next, at a step S310, using the camera 30, the control unit 10 detects the oncoming vehicle T.

Still next, at a step S320, using the distance detecting sensor 20, the control unit 10 measures the distance between the oncoming vehicle T and the self-vehicle. Moreover, based on this measured distance, the control unit 10 issues the instruction to the front lamps 90, thereby controlling the vertical-direction illumination angle of each front lamp of the self-vehicle. The concrete control method is basically the same as the one explained in FIG. 7.

Incidentally, in this case, the illumination angle of each front lamp 90 has been changed gradually, depending on the change in the inter-vehicles distance between the oncoming vehicle and the self-vehicle. The illumination angle, however, may be changed in a step-like manner: For example, if the inter-vehicles distance between the oncoming vehicle and the self-vehicle lies in the range of 100 to 300 meters, the illumination angle is changed to −2° and, if the inter-vehicles distance lies in the range of 50 to 100 meters, the illumination angle is changed to −4°.

As having been explained so far, the present embodiment permits the illumination angle of each front lamp to be changed depending on the distance between the oncoming vehicle and the self-vehicle. This condition makes it possible to prevent a visual illusion or confusion from being given to the driver of the oncoming vehicle.

According to the present invention, it becomes possible to enhance the safety of a running vehicle by using a camera.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A vehicle control apparatus, comprising:
a distance detecting sensor for detecting a distance between a vehicle and a self-vehicle, said vehicle being positioned ahead of said self-vehicle,
a camera for detecting said vehicle, said vehicle being positioned ahead of said self-vehicle,
control means responsive to a detection of the ahead-positioned vehicle by said sensor for determining a state of a rear lamp of said ahead-positioned vehicle utilizing said camera, and
communications means responsive to a detection of a malfunction of said rear lamp of said ahead-positioned vehicle by said control means, for communicating said malfunction to a driver of said ahead-positioned vehicle and/or a public agency.

2. A vehicle control apparatus, comprising:
a camera for detecting a vehicle, said vehicle being positioned ahead of a self-vehicle, and
control means for issuing a warning by alarm means if said control means has detected hard brake information on said vehicle by utilizing a signal from said camera, said vehicle being positioned ahead of said self-vehicle.

3. A vehicle control apparatus, comprising:
a camera for detecting a vehicle, said vehicle being positioned ahead of a self-vehicle, and
control means for outputting an instruction of full-closing of a throttle valve and/or an instruction of automatic control over a brake if said control means has detected hard brake information on said vehicle by utilizing a signal from said camera, said vehicle being positioned ahead of said self-vehicle.
